(19) United States
(12) Patent Application Publication
(10) Pub. No.: US 2023/0336101 A1
(43) Pub. Date: Oct. 19, 2023

(54) APPARATUS AND METHOD FOR DRIVING A PERMANENT MAGNET MOTOR

(71) Applicant: Vestel Elektronik Sanayi ve Ticaret A.S., Manisa (TR)

(72) Inventor: Seyit YILDIRIM, Manisa (TR)

(21) Appl. No.: 18/025,332

(22) PCT Filed: Sep. 8, 2020
(86) PCT No.: PCT/EP2020/075091

§ 371 Date: Mar. 8, 2023

(51) Int. Cl. H02P 21/00; H02P 21/22

(52) U.S. Cl. CPC H02P 21/0089; H02P 21/22; H02P 2201/03; H02P 2207/05

(57) ABSTRACT

There is provided a drive circuit (300) for a permanent magnet motor (311). The drive circuit (300) has a rectifier circuit constructed and arranged to convert a source alternating current (305) to a direct current, and a film capacitor (303) arranged in a path parallel with the rectifier circuit (307). The drive circuit (300) also has an inverter circuit (309) constructed and arranged to convert the direct current into a three-phase alternating current to drive the permanent magnet motor (311). Furthermore, the drive circuit (300) has a control circuit connected to the source alternating current (305) and the inverter circuit (309), the control circuit being constructed and arranged to modulate a d-axis current reference with the square of a cosine wave which is synchronised with a voltage angle of the source alternating current (305), wherein the modified d-axis current reference is provided as an input to the inverter circuit (309).

### TECHNICAL FIELD

The present disclosure relates to an apparatus and method for driving a permanent magnet motor.

### BACKGROUND

Electric motors are used in many devices and apparatus for many different purposes. Electric motors consume a lot of energy and there is always a demand to reduce power consumption and improve efficiency. Permanent magnet motors are increasingly being used to provide increased efficiency, as well as for other features. However, existing drive circuits for permanent magnet motors have various drawbacks.

### SUMMARY

According to an aspect disclosed herein, there is provided a drive circuit for a permanent magnet motor, the drive circuit comprising:

a rectifier circuit constructed and arranged to convert a source alternating current to a direct current;

a film capacitor arranged in a path parallel with the rectifier circuit;

an inverter circuit constructed and arranged to convert the direct current into a three-phase alternating current to drive a said permanent magnet motor; and

a control circuit connected to the source alternating current and the inverter circuit, the control circuit being constructed and arranged to modulate a d-axis current reference with the square of a cosine wave which is synchronised with a voltage angle of the source alternating current, wherein the modified d-axis current reference is provided as an input to the inverter circuit.

In an example, the film capacitor is arranged as a direct current link capacitor for the drive circuit.

In an example, the drive circuit is arranged such that an amplitude of the d-axis current reference is adjusted before being modulated by the control circuit.

The amplitude of the d-axis reference current may be increased so as to reduce the likelihood of disruptions in the torque control of a said permanent magnet motor.

The amplitude of the d-axis current reference may be decreased so that unnecessary d-axis current is not applied to the inverter circuit, causing the power factor of a said permanent magnet motor to drop.

In an example, the control circuit is constructed and arranged to modulate a q-axis current reference with the square of a sine wave which is synchronised with the voltage angle of the source alternating current, wherein the modified q-axis current reference is provided as a further input to the inverter circuit.

In an example, the drive circuit is arranged such that the amplitude of the q-axis current reference is adjusted with a proportional integral controller.

The amplitude of the q-axis reference may be adjusted in order to provide a motor speed that is substantially kept at a desired speed.

In an example, the control circuit comprises a voltage margin proportional integral controller constructed and arranged to determine a value for the d-axis current reference.

In an example, the drive circuit is arranged such that the voltage margin proportional integral controller uses a voltage margin reference value obtained via tuning the drive circuit at working conditions with a load to determine the d-axis current reference.

In an example, the drive circuit is arranged such that the d-axis current reference is determined by the voltage margin proportional integral controller at a zero-crossing event.

In an example, the control circuit comprises a grid angle generator, connected to the source alternating current, constructed and arranged to determine the voltage angle of the source alternating current.

In an example, in combination, there is a permanent magnet synchronous motor and the drive circuit for driving the permanent magnet synchronous motor.

According to another aspect disclosed herein, there is provided a method for driving a permanent magnet motor, the method comprising:

converting, at a power circuit, source single phase alternating current to three phase alternating current for a permanent magnet motor; and

applying feedback, comprising a modulated d-axis current reference, to the power circuit while the power circuit is converting the source single phase alternating current to the three phase alternating current, wherein the modulated d-axis current reference is determined by modulating a d-axis current reference with the square of a cosine wave which is synchronised with a voltage angle of the source single phase alternating current.

In an example, the method comprises adjusting an amplitude of the d-axis current reference before being modulated.

In an example, the feedback comprises a modulated q-axis current reference, the modulated q-axis current reference being determined by modulating a q-axis current reference with the square of a sine wave which is synchronised with the voltage angle of the source single phase alternating current.

In an example, the method comprises adjusting an amplitude of the modulated q-axis current reference.

In an example, the method comprises determining the d-axis current reference based on a voltage margin reference value obtained via tuning the power circuit at working conditions with a load.

In an example, the method comprises determining of the d-axis current reference is performed at a zero-crossing event.

In an example, the method comprises: determining the voltage angle of the source single phase alternating current; and providing the voltage angle of the source single phase alternating current to a sine waveform generator and a cosine waveform generator.

In an example, the method comprises performing one or more measurements of a current in the power circuit; and using the one or more current measurements to determine the feedback for the power circuit.

The method may be for driving a permanent magnet synchronous motor.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a circuit diagram of an example of a known single-phase to three-phase inverter drive circuit with an electrolytic capacitor;

FIG. 2 shows schematically an example of a single-phase to three-phase inverter drive circuit with a film capacitor according to the present disclosure;

FIG. 3 shows schematically another example of a drive circuit for a permanent magnet motor according to the present disclosure;

FIG. 4 shows an example waveform diagram for the drive circuit of FIG. 3; and

FIG. 5 shows schematically a portion of control circuity for a drive circuit for a permanent magnet motor according to the present disclosure.

### DETAILED DESCRIPTION

As mentioned, electric motors are used in many devices and products, in domestic settings, industrial applications, transportation vehicles, military applications, etc. A large part of electricity consumption in the world is due to electric motors. Given the scarce energy resources and rising energy costs in the world, it is essential to use electric motors as efficiently as possible. Indeed, the use of high efficiency electric motors in developed countries has become mandatory in most applications. Therefore, high efficiency motor design and efficient driving of these motors are increasingly important.

In many devices, including for example white goods applications, induction and brushed direct current (DC) motors are being replaced by permanent magnet motors such as, for example, permanent magnet synchronous motors (PMSMs) and brushless direct current motors (BLDCs). A permanent magnet synchronous motor is an alternating current (AC) motor that uses magnets embedded into or attached to the surface of the motor's rotor. The magnets are used to generate a constant motor flux instead of requiring the stator field to generate the flux by linking to the rotor, as is the case with an induction motor.

PMSMs can be more efficient than both induction and brushed DC motors. As well as this, PMSMs can operate in near silent operation and require much less maintenance in comparison to induction or brushed DC motors. Due to these features, PMSMs are advantageous to use in white goods applications over induction or brushed DC motors. However, driving a PMSM may not be as simple to implement as other motors, due to required inverter board and sometimes complex control systems.

Some of the following examples are described in relation to PMSMs, but it should be understood that some examples are also applicable to BLDC motors.

Typically, a drive circuit for a permanent magnet motor will comprise at least an AC to DC converter such as a rectifier circuit, and a DC to AC converter such as an inverter circuit. The drive circuit will usually convert single phase AC, which typical households will receive from the power grid, via a DC to three-phase AC to be output to drive the motor. The three-phases are three typical sine waveforms that are offset 120 degrees from each other. In three-phase power, at any given moment one of the three phases is nearing a peak. High-power three-phase motors and things like three-phase welding equipment and the like therefore have an even power input. Due to the AC to DC conversion in the drive circuit, often a capacitor is provided in the circuit. This capacitor is often known as a DC-link capacitor. A DC-link capacitor can charge while the AC source is high, and can discharge while the AC source is low. A DC-link voltage is the output voltage from the AC-DC conversion. Therefore, during a full cycle of source AC, the DC-link voltage will be provided by the converted AC voltage or the discharging DC-link capacitor. Therefore, having a DC-link capacitor provides a smoother output from the drive circuit.

Electrolytic capacitors can be used in PMSM drive circuits as DC-link capacitors. The electrolytic capacitor can keep the DC-link voltage flat so as to provide a high-quality power supply to the motor and hence a better motor performance. As discussed above, a DC-link capacitor is used in drive circuits to smooth the output voltage. DC-link capacitors can resolve the challenges of voltage and current ripples introduced by rapid switching in power conversions between AC to DC and vice-versa. If a DC-link voltage is kept almost constant, then traditional control can be applied. However, using an electrolytic capacitor in a drive circuit poses some challenges. Most notably the capacitor has a short lifetime, which may be much shorter than other parts of the drive circuit. Hence, this electrolytic capacitor in most cases determines the overall lifespan of the drive circuit. Also, such DC-link electrolytic capacitors are known to be unreliable. Other important issues about electrolytic capacitors include its large physical size and high cost. Moreover, large electrolytic capacitors cause a low input power factor and a high inrush current. Especially in industrial applications and home appliances such as white goods, these problems can be critical for safety, reliability and electromagnetic compatibility (EMC) requirements.

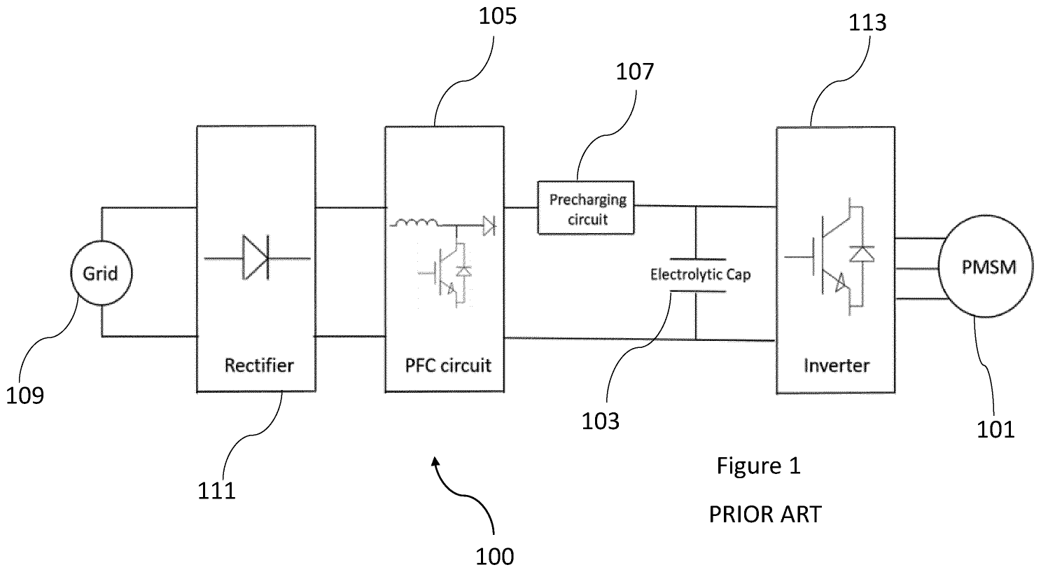

Referring now to the drawings, FIG. 1 shows schematically a circuit diagram of an example of a known single-phase to three-phase inverter drive circuit 100 with an electrolytic capacitor 103. The single-phase to three-phase inverter drive circuit 100 may be used for driving a PMSM 101. As seen in FIG. 1, the drive circuit 100 comprises an active or passive power factor correction (PFC) circuit 105 and a pre-charging circuit 107. As discussed above, using electrolytic capacitors can lead to a low input power factor and a high inrush current. The PFC circuit 105 is needed to address the low input power factor issues that are present due to the electrolytic capacitor 103. The pre-charging circuit 107 is needed to overcome the high inrush current issues caused by the electrolytic capacitor 103.

The drive circuit 100 is connected to an AC voltage source 109. The drive circuit 100 also comprises a rectifier circuit 111 and an inverter circuit 113. The rectifier circuit 111 is arranged in parallel with the AC source voltage 109. The PFC circuit 105 is arranged in parallel with the rectifier circuit 111. The pre-charging circuit 107 is arranged in series between the PFC circuit 105 and the inverter circuit 113. The electrolytic capacitor 103 is arranged in parallel with the PFC circuit 105. The inverter circuit 113 is arranged in parallel with the electrolytic capacitor 103. The output from the inverter circuit 113 is connected to the PMSM 101. The PFC circuit 105 and the pre-charging circuit 107 that are included to address problems related to the electrolytic capacitor have a high cost and can take up a lot of space in the apparatus generally but particularly on the circuit board (printed circuit board or PCB). In addition to the poor reliability of the electrolytic capacitor itself, the extra circuits that are needed can reduce the overall reliability of the system.

It has been proposed that control for a PMSM can be achieved with an inverter board using a film capacitor instead of an electrolytic capacitor. Film capacitors are capacitors with an insulating (usually plastics) film as the dielectric, sometimes combined with paper as the carrier of the electrodes. If a film capacitor is used, one or more of the previously discussed problems associated with using the large electrolytic capacitor in a drive circuit can be solved. A film capacitor in this situation can for example be substantially physically smaller than an electrolytic capacitor and can be less expensive to implement. The film capacitor may also have a smaller capacitance value when compared to an electrolytic capacitor.

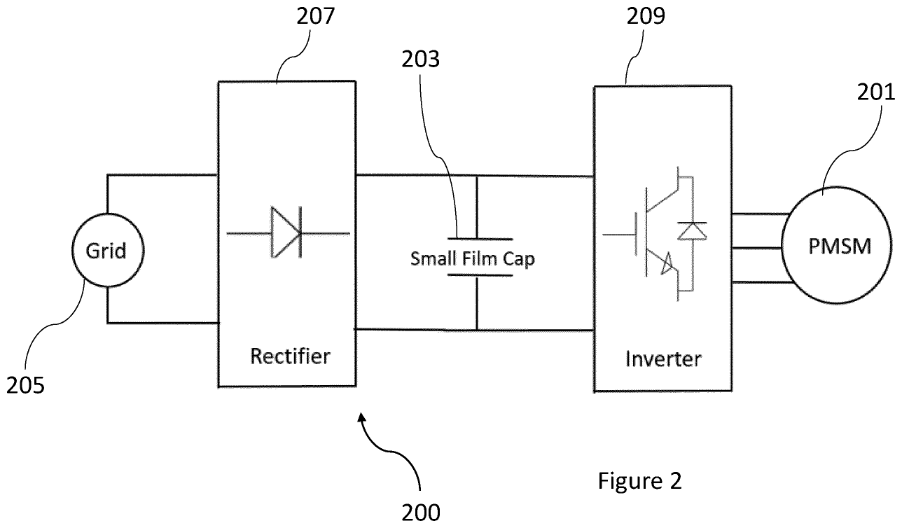

FIG. 2 shows schematically an example of a single-phase to three-phase inverter drive circuit 200 according to the present disclosure. The drive circuit 200 has a film capacitor 203. The single-phase to three-phase inverter drive circuit 200 may be used for driving a permanent magnet synchronous motor (PMSM) 201. In other examples, a different type of permanent magnet motor may be driven by the drive circuit 200, including for example a brushless direct current motor (BLDC). The capacitance value of the film capacitor 203 may be relatively small when compared to a large capacitance value of a typical electrolytic capacitor used in a similar drive circuit. The physical size of the film capacitor 203 may be relatively small when compared to the large physical size of an electrolytic capacitor. In other examples, other suitable capacitors with a relatively small capacitance value, other than electrolytic capacitors, may be used instead of a film capacitor. In the circuit of FIG. 2, the drive circuit 200 is connected to an AC voltage source 205. The drive circuit 200 also comprises a rectifier circuit 207 and an inverter circuit 209. The rectifier circuit 207 is in parallel with the AC source voltage 205. The film capacitor 203 is arranged in parallel with the rectifier circuit 207. The inverter circuit 209 is arranged in parallel with the film capacitor 203. The output from the inverter circuit 209 is connected to the PMSM 201.

As seen in FIG. 2, the circuit requires fewer components when compared to the circuit of FIG. 1. The cost of the system therefore decreases considerably. The size of the inverter board also decreases because of the smaller capacitor 203 used and the requirement for fewer components. This also improves the reliability of the system. All of these mentioned improvements are a source of motivation for industrial applications.

However, using a film capacitor in these type of drive circuits can bring control difficulties. If a film capacitor is used in a single-phase AC system, then the rectified DC-link voltage fluctuates at twice frequency of the AC source voltage frequency. As the output power increases, the DC-link voltage waveform will be similar to the rectified AC signal waveform. A fluctuating DC-link voltage can cause torque fluctuations and speed control difficulties in the motor that is being driven.

In order to overcome these problems, various correction techniques have been proposed in previous systems. Many proposals have attempted to overcome these problems by modifying the d-axis and q-axis current references of an inverter circuit because conventional field-oriented vector control is not sufficient for speed control of a PMSM driven by an inverter with a small film capacitor.

To explain further, in geometric terms, the so-called “d” and “q” axes are the single-phase representations of the flux contributed by the three separate sinusoidal phase quantities at the same angular velocity. The d-axis, also known as the direct axis, is the axis on which flux is produced by the field winding, such as the field winding in a PM motor. The q-axis, or the quadrature axis, is the axis on which torque is produced by a motor. The quadrature axis will always lead the direct axis electrically by 90 degrees. Put another way, the d-axis is the main flux direction, while the q-axis is the main torque-producing direction. In the field of PM motors, d-axis and q-axis current and voltage measurements can be important quantities for controlling the motors in open and closed loop feedback systems. In particular, d-axis and q-axis currents are important for “flux-weakening” operations. In particular, as PM motors comprise magnets, when the motor is operating at high speeds the rate of magnetic field flowing through a conductor's cross-section (i.e. the magnetic flux) can cause problems in the system. Due to the high speeds and high power of PMSMs, there is often a need for flux weakening operations to ensure that the system functions correctly. This will be discussed in more detail below.

There are two main approaches for implementing flux-weakening in PMSMs. One method is to improve the magnetic design of the motor, while the other is to use sophisticated electronic control techniques. The present disclosure particularly addresses control techniques for flux-weakening in PMSMs. A proper control strategy is needed to obtain the maximum output torque. The electronic control approach is based on the control of the stator current components, i.e. the d-axis and q-axis currents, to counter the fixed-amplitude magnetic airgap flux generated by the rotor magnets.

In field-oriented control, the two-axis electrical current components are the d-axis current and the q-axis current. In the present proposal, for the q-axis current, the shape of the q-axis current reference is modified as the square of a sinusoidal wave synchronized with an AC source voltage angle. This is the preferred approach, rather than an approach whereby the q-axis current reference was shaped as a trapezoidal waveform as a trapezoidal q-axis current reference causes poor input current harmonics compared to a sinusoidal q-axis current reference.

In regard to the d-axis current reference, a current reference value is calculated through a formula which is related to motor parameters. There have been various approaches used in previous systems to calculate a d-axis current reference. For example, it has been proposed that the d-axis current reference can be kept as a constant value according to the desired torque and speed. In other examples, the d-axis current reference changes slowly according to average voltage constraint concept. In a further example, the d-axis current reference is set at a negative constant value by trial-and-error by changing an operating point. In another example, a d-axis current reference waveform is chosen that has sharp peaks in the waveform. However, to achieve a stable control loop with such sharp peaks in the d-axis reference current, a proportional resonant (PR) controller must be used for current control. A PR controller is more difficult to implement in comparison to a proportional integral (PI) controller. Also, a sharp peak value of the d-axis current can be so high such that current threatens to demagnetize the motor. Due to the high d-axis current, insulated-gate bipolar transistors (IGBTs) must be used in the system to deal with the higher current carrying capacity. However, IGBTs have a high cost per unit. Therefore, in order to keep costs low, the use of IGBTs should be kept to a minimum or avoided in these type of circuits.

In order to address one or more of the problems identified above, it is proposed herein to apply a d-axis current to a drive circuit only when it is needed. In an electrolytic capacitor-less system, using for example a film capacitor, the DC-link voltage fluctuates at twice the frequency of the source AC due to the relatively small capacitance of the film capacitor, compared to when electrolytic capacitors are used. At the peak of the DC-link voltage, a system using a film capacitor can be considered as a relatively large capacity system. Therefore, there is less need for the d-axis current to be provided at, or around, a peak value of DC-link voltage under nominal speeds. In short, this is because the applicable source voltage is greater than the motor terminal voltage at the peak of the of DC-link voltage, and a flux weakening operation is therefore less useful here.

However, there is a greater need to provide a d-axis current at and around lower values of DC-link voltage. In particular, the applicable source voltage can be lower than the motor terminal voltage, and so a flux weakening operation can be useful here. A flux weakening operation can be achieved by providing a d-axis current into the drive circuit. The d-axis current is a negative current. The d-axis current may be provided to an inverter circuit, such as the inverter circuit 209 in FIG. 2. As a result, according to examples of embodiments of the present disclosure, a d-axis current waveform follows a square of a cosine wave (cos²(ϑ)) which is synchronized with an AC source voltage angle. This will be described in more detail below.

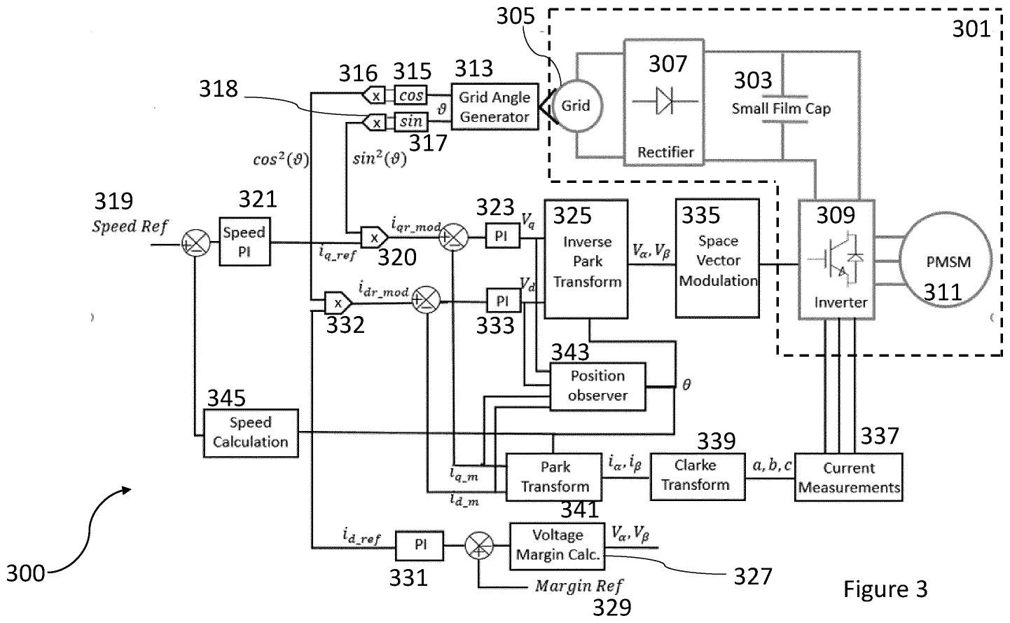

FIG. 3 shows schematically an example of a drive circuit 300 according to the present disclosure for a permanent magnet motor. As seen in FIG. 3, the drive circuit of this example is connected to a PMSM 311. In other examples, the drive circuit may be connected to a brushless DC motor. There is shown a power circuitry portion 301 of the drive circuit which is encapsulated with a dotted line. The remainder of the circuity in the drive circuit makes up the control circuitry of the drive circuit. The power circuitry 301 of FIG. 3 corresponds to the single-phase to three-phase inverter drive circuit of FIG. 2. The power circuitry 301 is connected in use to an AC voltage source 305, such as for example a national power grid or some other AC source. The power circuitry 301 comprises a rectifier circuit 307 and an inverter circuit 309. The rectifier circuit 307 is in parallel with the AC source voltage 305. A film capacitor 303 is arranged in parallel with the rectifier circuit 307. The inverter circuit 309 is arranged in parallel with the film capacitor 303. The output from the inverter circuit 309 is connected to the PMSM 311.

The control circuitry of the drive circuit 300 comprises a grid angle generator block 313. The grid angle generator 313 is connected in use to the AC voltage source 305. The grid angle generator is configured to calculate and output the AC voltage source angle. The output from the grid angle generator 313 is provided to a cosine block 315 and to a sine block 317. The cosine block 315 provides two outputs to a multiplication block 316 which in turn outputs a square of a cosine wave synchronised with the angle calculated by the grid angle generator 313. The sine block 317 provides two outputs to a multiplication block 318 which in turn outputs a square of a sine wave synchronised with the angle calculated by the grid angle generator 313.

In the following control circuit, different measurements can be calculated in either a stationary frame of reference or a rotating frame of reference. Frames moving with constant velocity with respect to each other are all inertial (stationary) frames. In a rotating reference frame, instead of co-moving with a linear velocity, there is rotation with some angular velocity.

A speed reference value 319 is provided to a speed PI block 321. The speed reference represents a desired speed of the PMSM 311. The speed reference value may be determined by a user of the PMSM 311. In other examples, the speed reference value may be determined by a user application, current operating characteristics of the device or an apparatus in which the motor is installed, etc. The speed reference value 319 may be configurable, and can be altered during operation of the PMSM 311. The output from the speed PI 321 is termed the q-axis current reference (i_{q_ref}). The q-axis current reference is in the rotating frame. The i_{q_ref} and the square of the sine wave is provided to a multiplication block 320 which outputs a modulated q-axis current reference (i_{qr_mod}). The modulated q-axis current reference is in the rotating frame. The i_{qr_mod} is provided to a PI controller 323 to output a q-axis voltage. The q-axis voltage is provided to an inverse Park transform block 325.

The inverse Park transform block outs an alpha voltage and a beta voltage. The alpha and beta voltage are based on the modulated q-axis and d-axis current references. The alpha and beta voltages are related to field-orientated vector control. The alpha and beta voltage values in the stationary frame are provided as an input into a voltage margin calculation block 327. The output from the voltage margin calculation block 327 is subtracted from a margin reference value 329 and fed into a second PI 331. The margin reference value 329 may be stored as a constant value in the drive circuit. In other examples, the margin reference value 329 may be configurable. The output of the second PI 331 is a d-axis current reference (i_{d_ref}). The d-axis current reference is in the rotating frame. The i_{d_ref} and square of the cosine from the multiplication block 332 is provided into a multiplication block to output a modulated d-axis current reference (i_{dr_mod}). The modulated d-axis current reference is in the rotating frame. The i_{dr_mod} is provided to a third PI 333 to output a d-axis voltage. The d-axis voltage is in the rotating frame. The d-axis voltage is provided to the inverse Park transform block 325. The output from the inverse Park transform block 325 is the q-axis and d-axis voltage in a rotating frame. The q-axis and d-axis voltage are provided to a space vector modulation block 335. The output from the space vector modulation block 335 is provided to the inverter 309 of the power circuitry 301.

A current measurement block 337 is connected to the inverter 309. The current measurement block 337 is configured to measure one or more currents flowing through the inverter 309. In this example, the current measurement block 337 measures three currents of the three-phases of AC that are being output by the inverter circuit 309. The output from the current measurement block 337 is provided to a Clarke transform block 339. The Clarke transform block 339 outputs an alpha current and a beta current. Both the alpha current and the beta current are in a stationary frame. The alpha current and the beta current are provided to a Park transform block 341. The Park transform block 341 has a first output which is a measured q-axis current in a rotating frame. The first output is subtracted from the i_{qr_mod} before the PI 323. The Park transform block 341 has a second output which is a measured d-axis current in a rotating frame. The second output is subtracted from the i_{dr_mod} before the third PI 333. A position observer block 343 is connected to the output of the PI 323, the output of the third PI 333, and first and second outputs from the Park transform block 341. The position observer block 343 outputs a rotor electrical angle from phase A. In this regard, the PM motor has three phases A, B, C (sometimes also called U, V, W). The rotor electrical angle in phase A is the angular distance between the rotor (i.e. magnet) and stator phase A, etc. The rotor electrical angle is provided to the inverse Park transform block 325, the Park transform block 341, and a speed calculation block 345. The speed calculation block 345 outputs a determined speed. The determined speed is subtracted from the speed reference value 319 before the speed PI block 321.

As seen in FIG. 3, the q-axis current reference (i_{q_ref}) is modified as the square of sinusoidal wave (sin₂(ϑ)) synchronized with AC source voltage angle. Further, in accordance with embodiments of the present disclosure, the d-axis current reference (i_{d_ref}) is modified as the square of cosine wave synchronized with the AC source voltage angle from multiplication block 316. In this way, the d-axis current is applied when it is most useful, for example, when the DC-link voltage is at lower values. By applying the d-axis current in this manner, the system will keep the PMSM in the motor region instead of the regenerative region. Motors can act as generators if functioning in a reverse manner, in what is known as the regenerative region, and this is avoided in accordance with the present disclosure.

In summary, as mentioned previously, the DC-link voltage fluctuates at twice the frequency of the AC source (from for example the grid) due to the relatively small capacitance of the film capacitor. At the peak of the DC-link voltage, a system using a film capacitor can be considered as operating as a relatively large capacitance system. Therefore, there is less need for a d-axis current (i.e. flux weakening) to be provided at, or around, a peak value of DC-link voltage under nominal speeds. The applied source voltage is greater than the motor terminal voltage, and so there a flux weakening operation is less useful here.

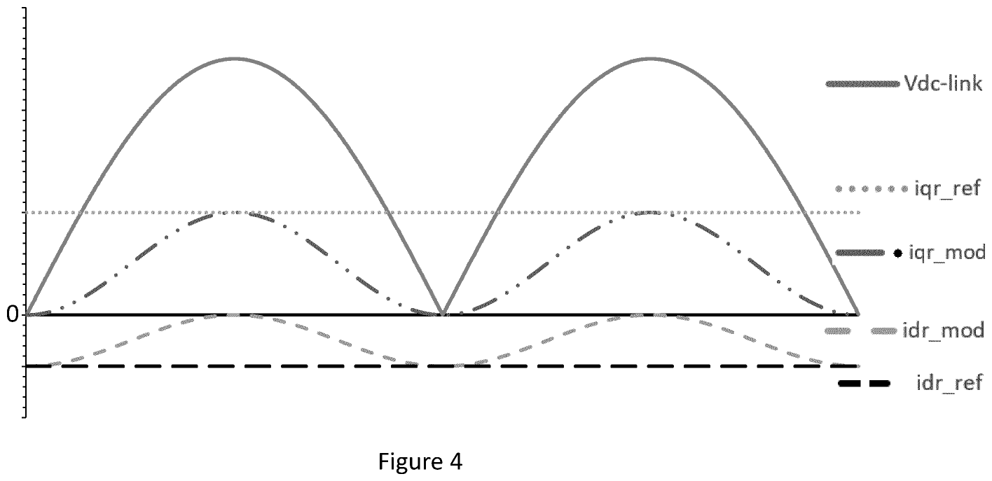

On the other hand, d-axis current for flux weakening is useful around lower values of the DC-link voltage because the applicable source voltage is lower than the motor terminal voltage. As provided herein, the d-axis current waveform follows a square of a cosine wave which is synchronized with a determined AC source voltage angle, as seen in FIG. 4.

FIG. 4 shows an example waveform diagram for the drive circuit of FIG. 3. The waveform diagram includes a q-axis current reference line (iqr_ref), a d-axis current reference line (idr_ref), a modulated q-axis current reference waveform (iqr_mod), a modulated d-axis reference waveform (idr_mod) and a DC-link capacitor voltage waveform (Vdc-link).

The q-axis current reference line (iqr_ref) is marked as a horizontal line showing a constant positive amplitude. The d-axis current reference line (idr_ref) is marked as a horizontal line showing a constant negative amplitude. In this example, the positive amplitude of the q-axis current reference (iqr_ref) is greater than the negative amplitude of the d-axis current reference (idr_ref).

The DC-link voltage waveform (Vdc-link) is a square of a sine wave. The modulated q-axis current reference (iqr_mod) is also a square of a sine wave. The peak of the modulated q-axis current reference waveform (iqr_mod) has the same amplitude as the q-axis current reference line (iqr_ref). The DC-link voltage and the modulated q-axis current reference waveform (iqr_mod) are in phase with each other. The peak amplitude of the DC-link voltage waveform (Vdc-link) is greater than the peak amplitude of the modulated q-axis current reference waveform (iqr_mod). The modulated d-axis current reference waveform (idr_mod) is a negative waveform. The modulated d-axis current reference waveform (idr_mod) is a square of a cosine wave. The peak negative amplitude of the modulated d-axis current reference waveform (idr_mod) has the same amplitude as the d-axis current reference line (iqr_ref).

When the DC-link voltage wave (Vdc-link) is at peak amplitude, the modulated d-axis current reference waveform (idr_mod) has a minimum value. This is showing that a minimum amount of d-axis current is being provided to the inverter circuit of the drive circuit of FIG. 3. As discussed previously, when the DC-link voltage is at a peak amplitude then a flux-weakening operation is not as useful or may not be needed. Therefore, little to no d-axis current is provided to the inverter circuit.

When the DC-link voltage wave (Vdc-link) is at a minimum, the modulated d-axis current reference waveform (idr_mod) is at the peak negative amplitude. This is showing that the maximum amount of d-axis current is being provided to the inverter circuit of the drive circuit. Again, d-axis current is useful around lower values of DC-link voltage because the applicable source voltage is lower than the motor terminal voltage. Therefore, a flux weakening operation is useful in this situation. It should be understood that in this example of FIG. 4, a minimum amplitude refers to a zero crossing, or close to zero crossing.

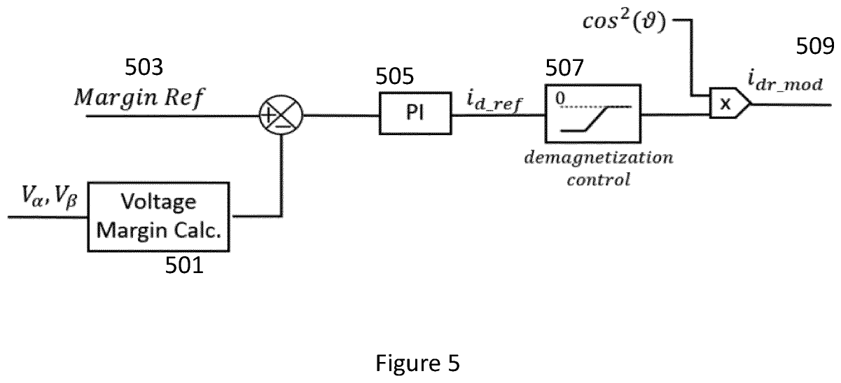

FIG. 5 shows schematically an example control circuit diagram. The control circuit diagram of FIG. 5 shows part of the circuitry from the control circuit of FIG. 3 in more detail. The function of the circuitry of FIG. 5 is to generate a d-axis current reference value. There is provided a voltage margin calculation block 501. An alpha and a beta voltage (V_{α}, V_{β}) in a stationary frame are provided as inputs to the voltage margin calculation block 501. The voltage margin is the difference between a maximum applicable source voltage and a motor terminal voltage. There is also provided a margin reference value 503. The output from the voltage margin calculation block 501 is subtracted from the margin reference value 503. The calculated value is provided to a PI 505. The output from the PI 505 is the d-axis current reference (i_{d_ref}) The d-axis current reference passes through a demagnetisation control block 507. A modulated d-axis current reference 509 is generated by multiplying d-axis current reference with the square of a cosine wave which is synchronized with a determined AC source voltage angle (cos₂(ϑ)).

If the voltage margin reference value 503 is too high, then unnecessary extra d-axis current would be applied. The extra d-axis current could cause the power factor of the PM motor to drop. If the voltage margin reference value 503 is too low, then there could be disruptions in torque control of the PM motor. Disruptions in the torque control could be due to a lack of d-axis current. Therefore, the voltage margin reference value 503 is obtained with fine tuning at working conditions with a load. In order not to disturb the sinusoidal waveform of the modulated d-axis current reference and the modulated q-axis current reference, the d-axis current reference and the q-axis current reference are determined at every zero-crossing event.

Thus, the present disclosure can provide improved input current harmonics for PM motor driving applications. The drive circuit may be can be more efficient and provide the greatest power output to the PM motor. This leads to a higher power factor compared to previous systems at nominal speed conditions and therefore greater efficiency whilst enabling stable operation of the motor. The circuits and methods may be suitable for driving PM motors such as brushless DC motors and PMSMs. The circuits and methods disclosed herein may be particularly suited in various electrical appliances, including for example white goods appliances, such as for example air conditioners, and other domestic or industrial appliances.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A drive circuit for a permanent magnet motor, the drive circuit comprising:
a rectifier circuit constructed and arranged to convert a source alternating current to a direct current;
a film capacitor arranged in a path parallel with the rectifier circuit;
an inverter circuit constructed and arranged to convert the direct current into a three-phase alternating current to drive a said permanent magnet motor; and
a control circuit connected to the source alternating current and the inverter circuit, the control circuit being constructed and arranged to modulate a d-axis current reference with the square of a cosine wave which is synchronised with a voltage angle of the source alternating current, wherein the modified d-axis current reference is provided as an input to the inverter circuit.

2. A drive circuit according to claim 1, arranged such that an amplitude of the d-axis current reference is adjusted before being modulated by the control circuit.

3. A drive circuit according to claim 1, wherein the control circuit is constructed and arranged to modulate a q-axis current reference with the square of a sine wave which is synchronised with the voltage angle of the source alternating current, wherein the modified q-axis current reference is provided as a further input to the inverter circuit.

4. A drive circuit according to claim 3, arranged such that the amplitude of the q-axis current reference is adjusted with a proportional integral controller.

5. A drive circuit according to claim 1, wherein the control circuit comprises a voltage margin proportional integral controller constructed and arranged to determine a value for the d-axis current reference.

6. A drive circuit according to claim 5, arranged such that the voltage margin proportional integral controller uses a voltage margin reference value obtained via tuning the drive circuit at working conditions with a load to determine the d-axis current reference.

7. A drive circuit according to claim 5, arranged such that the d-axis current reference is determined by the voltage margin proportional integral controller at a zero-crossing event.

8. A drive circuit according to claim 1, wherein the control circuit comprises a grid angle generator, connected to the source alternating current, constructed and arranged to determine the voltage angle of the source alternating current.

9. In combination, a permanent magnet synchronous motor and a drive circuit according to claim 1 for driving the permanent magnet synchronous motor.

10. A method for driving a permanent magnet motor, the method comprising:
converting, at a power circuit, source single phase alternating current to three phase alternating current for a permanent magnet motor; and
applying feedback, comprising a modulated d-axis current reference, to the power circuit while the power circuit is converting the source single phase alternating current to the three phase alternating current, wherein the modulated d-axis current reference is determined by modulating a d-axis current reference with the square of a cosine wave which is synchronised with a voltage angle of the source single phase alternating current.

11. A method according to claim 10, comprising adjusting an amplitude of the d-axis current reference before being modulated.

12. A method according to claim 10, wherein the feedback comprises a modulated q-axis current reference, the modulated q-axis current reference being determined by modulating a q-axis current reference with the square of a sine wave which is synchronised with the voltage angle of the source single phase alternating current.

13. A method according to claim 10, comprising determining the d-axis current reference based on a voltage margin reference value obtained via tuning the power circuit at working conditions with a load.

14. A method according to claim 10, comprising:
determining the voltage angle of the source single phase alternating current; and
providing the voltage angle of the source single phase alternating current to a sine waveform generator and a cosine waveform generator.

15. A method according to claim 10, comprising:
performing one or more measurements of a current in the power circuit; and
using the one or more current measurements to determine the feedback for the power circuit.
